(19) United States
(12) Patent Application Publication
(10) Pub. No.: US 2004/0103622 A1
(43) Pub. Date: Jun. 3, 2004

(54) Magnetic equine hood

(76) Inventor: Joanne H. Nor, Rancho Santa Fe, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/723,525

(22) Filed: Nov. 25, 2003

Related U.S. Application Data
(60) Provisional application No. 60/430,031, filed on Nov. 30, 2002.

(51) Int. Cl. B68B 1/04

(52) U.S. Cl. 54/6.1

(57) ABSTRACT

A magnetic equine hood for applying magnetic therapy to an equine neck, cervical vertebrae, atlas, axis, head, back, and shoulders is disclosed. A head portion shaped to substantially conform to an equine neck is attached to a neck portion defining a volume substantially conforming to an equine neck. Magnetic strips are strategically coupled to the neck portion to create magnetic fields radiating towards areas where therapeutic treatment is desired to increase circulation in those areas. For instance, magnetic strips may be detachably coupled to the neck portion on either side of a cervical vertebrae. Additionally, an optional atlas and axis magnetic strip can be detachably coupled in position along the equine neck to create a magnetic field radiating towards the equine atlas, axis, and poll. Moreover, the hood can be permanently or detachably coupled to an equine blanket that may also use magnetic therapy.

This application claims the priority of Provisional Patent Application No. 60/430,031 (pending) filed on Nov. 30, 2002.

### BACKGROUND OF THE INVENTION

1. Field of the Invention

The present invention relates to magnetic field therapy. More particularly, the invention relates to an apparatus for applying magnetic fields to an equine neck, head, shoulders, and back.

2. Background

Magnetic field therapy for increasing blood flow has been applied to various areas of equine anatomy to treat acute or chronic conditions, including horses' backs, knees, hocks, cannons, fetlocks, feet, etc. Various wraps, blankets, pads and so forth have been developed for this purpose.

Often times, horses using draw reins and/or in heavy training experience pressure at the neck and/or poll (e.g., just behind the ears), and cervical, lower lumbar, sacral and back pain. In addition, various musculosketal injuries and pathologies may occur in horses during their daily routines, and participation in various competitions. These problems may be chronic and degenerative, or in any event, take a very long time to heal. However, recovery from or healing of some of these problems may be expedited by increased circulation in the problem or injured area including bone, muscle, soft tissue, fascia, and ligaments.

In addition, increased blood flow may assist in warm up, pain relief, soothing and relaxing aching joints, soft tissue, ligaments, and muscles, and shortening injury recovery time by promoting circulation. For example, it has been clinically proven by nuclear scintigraphy studies at various universities and hospitals that increased blood flow decreases the rate of degeneration and also speeds healing of inflammation.

### BRIEF DESCRIPTION OF THE DRAWINGS

FIG. 1 is a perspective view of a magnetic equine hood placed on a horse, according to one embodiment.

FIG. 2 is a top plan view of a magnetic equine hood, according to one embodiment.

FIG. 3 is a top plan view of a magnetic equine hood, showing an optional atlas/axis pad, according to one embodiment.

FIG. 4 shows a partial plan view of the magnetic distribution of the magnetic strips of the hood, according to one embodiment.

FIG. 5 is a cross-sectional view showing the magnetic distribution in the magnetic strips in the hood, according to one embodiment.

FIG. 6 is a perspective view of an equine blanket and magnetic equine hood placed on a horse, according to one embodiment.

### DETAILED DESCRIPTION OF THE INVENTION

FIG. 1 is a perspective view of a magnetic equine hood placed on a horse, according to one embodiment. As shown, the hood generally referred to as 100, is shown placed about, encasing, and/or secured to an equine head and neck (e.g., to substantially conform to the head and neck of a horse). Hence, for instance, hood 100 may be placed so as to form a perimeter that runs substantially along all of an equine's neck vertebrae, such as by a perimeter encompassing a horse's entire cervical vertebrae. As shown, hood 100 includes head portion 110 and neck portion 130. Head portion 110 may have a shape substantially conforming to or approximating an equine head (e.g., such as shown at head 102) when used. Head portion 110 includes cutout opening or hole 112 for equine ear 108, and cutout opening or hole 116 for around equine eye 107. Ear cutout 112 is shown having lining 114 along the perimeter cutout 112, and eye cutout 116 is shown having lining 118 along the perimeter of cutout 116. As shown, hooded portion 110 may cover an equine forehead and face and extend to an equine muzzle 106. For instance, muzzle 106 can extend through muzzle opening 120 having lining 121 along the perimeter of opening 120. Although opening 120 is shown providing adequate space the horse's muzzle, nose and mouth, a larger or smaller opening may be used. Head portion 110 can also have attachment strap 122 to detachably couple head portion 110 about muzzle 106.

According to embodiments, cutout linings, such as linings 114 and 118 may be a padded lining attached, for example, by stitching along the perimeter of the cutouts to reduce irritation and increase comfort to the horse during use of the hood. Also, head portion 110, neck portion 130, attachment strap 122, and cutout linings (e.g., such as linings 114 and 118) may be constructed from various materials including a mixture of polyester, rayon, wool, cotton, an elastic webbing or other durable natural or synthetic material, and/or a wicking material. For example, an equine hood designed for use during the winter season may have a head portion, neck portion, attachment straps, and/or cutout linings may be constructed of two sheets of 100% cotton to reduce irritation, or one or two sheets of a wicking material such as DuPont COOLMAX®, CORDURA fabric that is shaped to conform to or define a volume conforming to a horse's head and neck for proper fit and/or is shaped to conform to the perimeter of a cutout. Furthermore, an equine hood designed for use during the summer season may have a head portion, neck portion constructed of a material that breaths better or keeps the animal cooler than the winter design such as one or more sheets nylon mesh (e.g., such as a “fishnet” type mesh having small holes) or wicking material that is shaped to conform to or define a volume conforming to a horse's head and neck for proper fit. Note that the although above configurations of hood material are described with respect to certain seasons of the year, use of those configurations during any or all seasons is within the scope and contemplation of the invention.

In some embodiments, lining 121 has a loop-like material or hook material outer surface or backing to engage a segment of hook material or loop-like material (not shown here) disposed adjacent to or on an inner surface or receive position of the end of attachment strap 122. Instances of a suitable hook material include a synthetic material which adheres when pressed together, such as the materials sold under the trademark VELCRO®. In one embodiment, lining 121 may be coupled or fastened to strap 122 using other fastening mechanisms, including buckles, snaps, buttons, tabs and so forth. In addition, attachment strap 123 can be overlaid across the lower jaw and detachably coupled, as shown, to assist in encircling or securing the horse's head with head portion 110. For instances, strap 123 can be a material and have engaging materials similar to those described above for strap 122. Embodiments also include head portion 110 closed about or detachably secured to an equine head without any attachment straps, with one attachment strap, or with any appropriate number of attachment straps, such as the straps described with respect to straps 122, lining 121, and strap 123.

Attached to head portion 110, FIG. 1 shows neck portion 130 defining a volume substantially conforming to an equine neck. Thus, neck portion 130 can have side walls with a shape approximating an equine or horse neck (e.g., such as shown at 104) and may be adapted to conform in shape to an equine neck when used. Neck portion 130 is attached to head portion 110 along or proximate to throat strap 124, which runs along a front edge perimeter of neck portion 130 and a rearward edge perimeter of head portion 110. Thus, neck portion 130 encases, encircles, surrounds, and/or is secured to horse neck 104. The attachment or coupling of neck portion 130 to head portion 110 may be by sewing, stitching, adhesive, heat, welding or any other conventional manner. Embodiments also include where head portion 110 and neck portion 130 consist substantially of one piece of material or have material crossing under throat strap 124, so that they are joined together without requiring coupling.

Neck portion 130 includes one or more magnetic strips coupled to the neck portion for creating a magnetic field, such as, a bipolar magnetic field radiating from the magnetic strip towards an equine neck, cervical vertebrae, or volume disposed within the neck portion. For example, neck portion 130 may include side walls for encasing or encircling an equine neck and detachably coupled to these side walls may be one or more flexible strips of magnetic material located proximate to either side of a cervical vertebrae of the equine neck for radiating a magnetic field from the magnetic strips towards the volume of equine neck surrounded by the neck portion. Embodiments include magnetic strips for radiating a magnetic field from the strips and towards an equine cervical vertebrae and the soft tissue, muscle, bone, fascia, and ligaments in and around an equine neck. Moreover, neck portion 130 may contain magnetic strips comprising a magnetic material layer laminated between a first and second fibrous layer or magnetic materials embedded into the strip material. Magnetic strips may also comprise flexible magnetic bands contained in a wick material or any other appropriate material such as those used in the construction of the hood portion and/or neck portion as explained above with respect towhead portion 110 and neck portion 130, attachment 122, and linings 114 and 118.

According to embodiments, magnetic strips may also include a magnetic paste, a magnetic plastic, a magnetic metal, a magnetic alloy, a magnetic composite, a magnetic resin, and/or a magnetic epoxy. Moreover, a plurality of magnetic fields, including the materials described above, arranged such that pairs of adjacent magnets or magnetic fields have a bipolar or unipolar magnetic arrangement is within the scope and contemplation of the invention. In particular, magnetic strips may contain a plurality of magnetic field polarities (e.g., 15-150 by 18-20 magnetic field polarities along a top plane surface such as shown by magnetic strip surface 150 in FIG. 2, or various other numbers of magnetic field polarities as necessary to produce the desired overall magnetic field) and may be attached, coupled to, or located in one or more sets of two strips at positions juxtapositioned with respect to areas of an equine to the neck, atlas, axis, or cervical vertebrae. For instance, magnetic strips may be strategically positioned along or about the spinal area or cervical vertebrae to treat a horse. Moreover, magnetic strip may include magnetic material comprising a plurality of permanent magnets or other magnetic material in a bipolar arrangement or unipolar arrangement inner layer sandwiched between layers including rubber, fibrous layers, plastic, vinyl or the like. One suitable magnetic layer is described in U.S. Pat. No. 4,489,711 issued to Latzke; however, other magnetic materials having magnets with different magnetic patterns can also be used. Also, magnetic materials can be embedded into a fibrous substrate to form the magnetic material or strip.

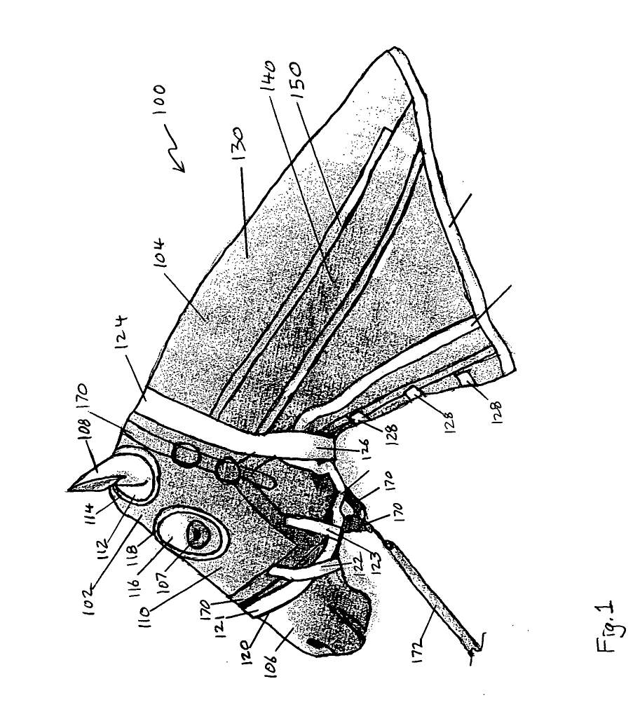

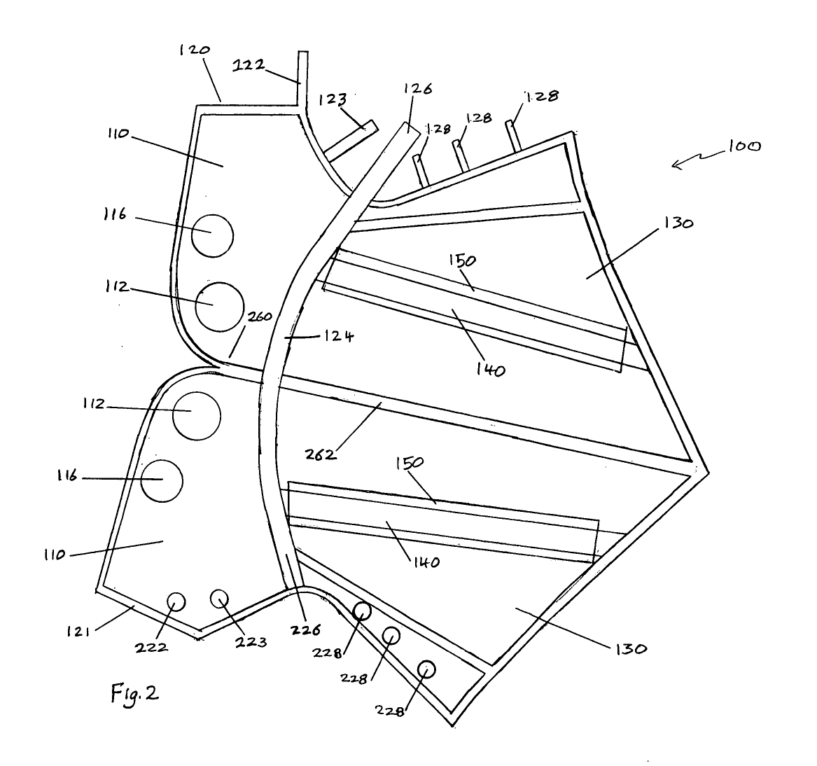

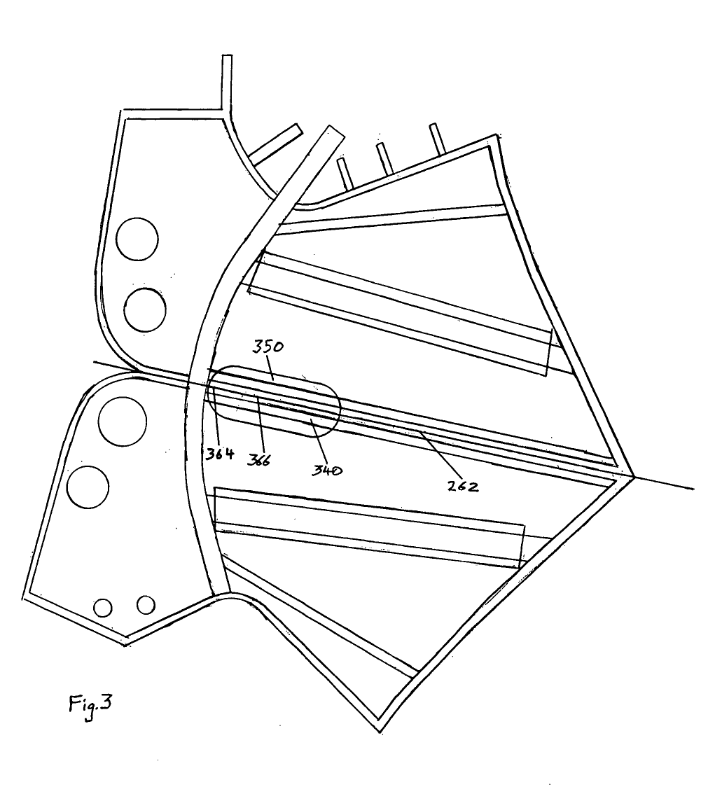

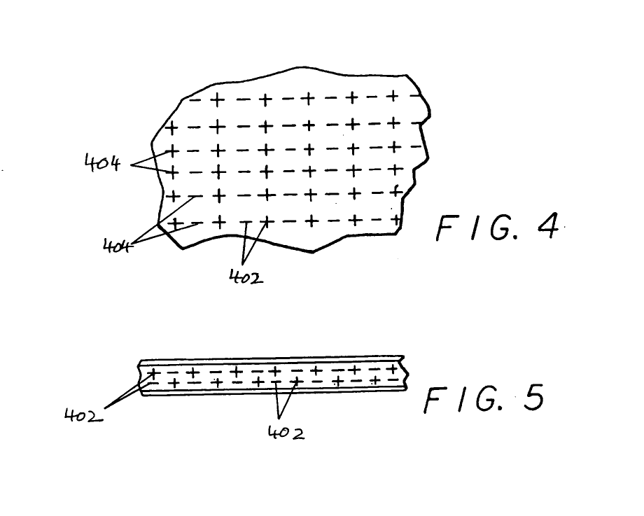

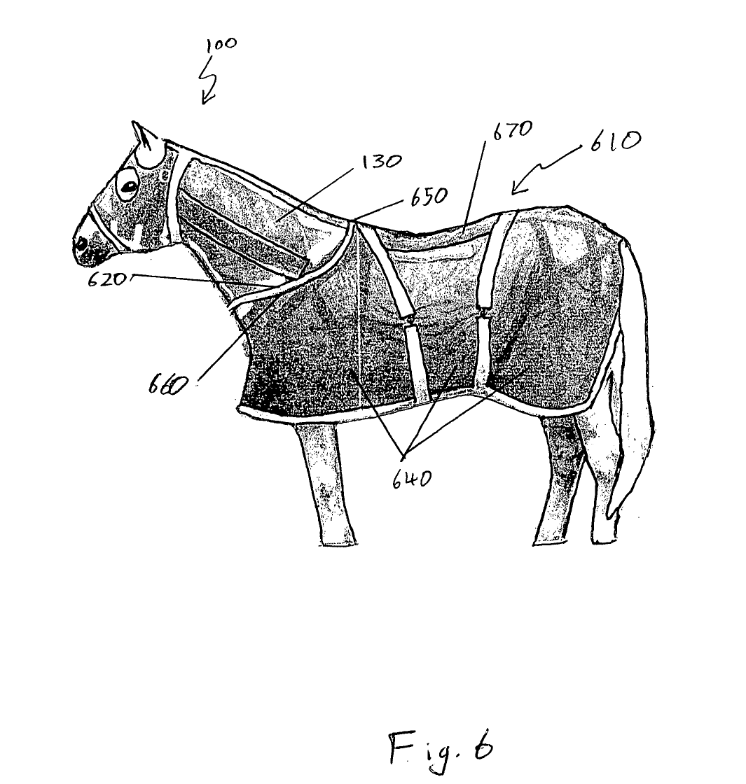

FIG. 4 shows a partial plan view of the magnetic distribution of the magnetic strips of the hood, according to one embodiment. FIG. 5 is a cross-sectional view showing the magnetic distribution in the magnetic strips of the hood, according to one embodiment. As can be seen from these figures, adjacent magnetic field polarities have reverse polarities 402 such that what is known as “a bipolar magnetic field” is created. It is also within the scope and contemplation of the invention that the magnetic material is arranged such that all magnetic poles have the same polarity or “face” the same way (not shown herein for all magnetic poles facing the same way, but two adjacent magnetic poles having the same polarity is shown at 404), creating what is known as a “unipolar magnetic field” within the sock. Other distributions and patterns of magnetic material other than those shown in FIGS. 4 and 5 are within the scope and contemplation of the invention. The magnetic field strength should be in the range of about 50-2000 gauss. Excellent results have been obtained in the products with magnetic strips each, or in combination having a field strength of approximately 450 gauss. Specifically, results have been obtained using two strips of bipolar magnetic material mounted along the neck sides at opposing regions on each side of the cervical vertebrae, where each strip is on the order of 25-½ inches by 5 inches and produces a field strength on the order of 450 gauss. Moreover, magnetic poles can be spaced apart approximately 15 mm in the magnetic strip and may be covered by fabric or material as explained above. Also, magnetic strip 150 may include a tab without fastener material, such as hook or loop-like material to facilitate in removal of the strip from the hood portion.

Embodiments account for treatment of an equine by magnetic material or strips creating a magnetic field that acts on an equine neck, atlas, axis, poll, cervical vertebrae, shoulders, head, and/or back when the magnetic strips are located proximate to the horse neck or area to be treated or acted on as explained above. It is within the scope and contemplation of the invention that the magnetic material may be present in more than one or two strips located along the equine neck and/or cervical vertebrae.

Embodiments also include neck portion 130 closed about or detachably secured to an equine neck without any attachment straps, with one attachment strap, or with any appropriate number of attachment straps and strap material and means attachment straps, such as the straps described above with respect to straps 122, lining 121, and strap 123, and lining 121. For instance, as shown in FIG. 1, neck portion 130 has attaching straps 128 for encasing, encircling, surrounding, and/or securing neck portion 130 to equine neck 104. Moreover, throat strap 124 includes throat attachment strap 126 for securing throat strap 124 about the horse's throat. Straps 128 and 124 can include a material and have engaging materials and means similar to those described above with respect to strap 122 and lining 121. Thus, the weight of the magnetic equine hood 100 and attachment straps 122, 123, 126 and 128 may each assist in securing the hood 100 to the horse, as well as to ensuring magnetic field from magnetic strips 150, are located proximate to desired areas around and at the equine neck 104, head 102, back, cervical vertebrae, and shoulders.

In one embodiment, magnetic strip 150 is fastened to mounting strip 140 using hook material and loop-like material as described above with respect to attachment strap 122 and lining 121. Use of such hook and loop-like material fasteners to attach magnetic strip 150 to attachment strip 140 provides for adjustment of the orientation and position of magnetic strip 150 with respect to neck 104 and/or cervical vertebrae. However, other fastening mechanisms, including buckles, snaps, buttons, tabs and so forth are within the scope and contemplation of the invention. Furthermore, according to embodiments, magnetic strip 150 may be fixedly coupled to neck portion 130.

With reference to FIG. 1, hood 100 is shown as it is placed on a horse. Only one side of the horse is shown for illustration, however, the structure shown in FIG. 1 may be placed symmetrically or non-symmetrically in positions on the opposite side of the horse. For example, FIG. 2 is a top plan view of a magnetic equine hood, according to one embodiment. As shown in FIG. 2, hood 100 includes eye-cutouts 116, ear-cutouts 112, muzzle opening 120, muzzle lining 121, attachment straps 122, 123, 126 and 128. FIG. 2 also shows throat strap 124 going over the equine crest position of hood 100, intersecting equine crest line 262 just behind equine poll position 260. On throat strap 124, opposite to throat strap attachment strap 126 is throat strap attachment location 226. Additionally, shown are attachment location 222 for attachment strap 122, attachment location 223 for attachment strap 123, and attachment locations 228 for attachment straps 128. Attachment straps 122, 123, 126 and 128, as well as attachment locations 222, 223, 226 and 228 may comprise material and have attachment material or means similar to that described above with respect to strap 122 and lining 121.

As shown in FIG. 2, mounting strips 140 run lengthwise along neck portions 130 and allow magnetic strips to be mounted along the inner or outer surface of hood 100 in various positions and orientations with respect to an equine neck and/or cervical vertebrae. Thus, for example, mounting strips 140 may be hook or loop-like fastener material disposed along the inside of neck portion 130 for engaging look-like or hook type fastener material that is mounted on a surface of magnetic strip 150.

Moreover, additional magnetic strips may be incorporated on the inside or outside surface of hood 100 along top centerline 262 or along a bottom centerline (e.g., running along the bottom of an equine face, throat, and neck). For example, FIG. 3 is a top plan view of a magnetic equine hood, showing an optional atlas/axis pad, according to one embodiment. As shown, an optional atlas, axis, and/or cervical vertebrae pad can be incorporated with hood 100, by coupling atlas, axis, and/or cervical vertebrae magnetic strip 350 to mounting strip 340, which can be located on the inside or outside of hood material prior to placing hood 100 over the horse. Thus, atlas, axis, and/or cervical vertebrae magnetic strip 350 may be detachably coupled to neck portion 130 proximate to equine atlas position 364 and equine axis position 366 of a horse by mounting atlas and axis magnetic strip 350 to mounting strip 340 which runs along the central line or crest line 262 of the horse or equine neck and/or cervical vertebrae. Note that an equine atlas position corresponds to the location of an equine first cervical vertebra (e.g., to the first cervical vertebra of a horse). For instance, equine atlas position 364 is located proximate to the top or dorsal position of throat strap 124, as shown in FIG. 1. Also, an equine axis position is generally located approximately 2″-6″ below the atlas position along the dorsal crest line, such as crest line 262 shown in FIG. 2. For example, equine axis position 366 can be located approximately 4″ below equine atlas position 364. Hence, an atlas, axis, and/or cervical vertebrae magnetic strip made of flexible magnetic material may to be detachably attached to a dorsal position of hood 100 on the inside surface of hood 100 along central line 262 and proximate to neck portion 110. In this manner, optional atlas, axis, and/or cervical vertebrae magnetic strip 350 can create a magnetic field radiating from that strip towards a region of volume occupied by an equine atlas and axis and cervical vertebrae.

Also, atlas, axis, and/or cervical vertebrae magnetic strip 350 may have magnetic material arranged in a bipolar and/or unipolar arrangement, as described above with respect to magnetic strip 150. Moreover, atlas, axis, and/or cervical vertebrae magnetic strip 350 may include material, material covering, and/or lining material, as described above with respect to head portion 110, neck portion 130, and linings 114 and 118. Furthermore, atlas, axis, and/or cervical vertebrae magnetic strip 350 may be detachably coupled to neck portion 130 using hook and loop material, and/or attachment straps, such as described above with respect to attachment material and means for strap 122 and lining 121. For example, each flexible magnetic material strip may have a hook material backing or a loop-like material backing for detachably coupling to a loop-like material receive or a hook material receive on the inside or outside surface of neck portion 130. Conversely, according to embodiments, magnetic strip 350 may be fixedly coupled to neck portion 130.

Therefore, the placement of each magnetic strip at a strategic area of the hood, such as is shown by the location of magnetic strips 150 in FIGS. 1 and 2, and magnetic strip 350 in FIG. 3, enables hood 100 to provide and soothing magnetic therapy and reduce pain to the joints, ligaments, tendons, fascia, and muscle groups of the horse's neck, cervical vertebrae, head, shoulders, and poll. The magnetic therapy delivered by hood 100 is effective in treating soreness and stiffness along the neck, cervical vertebrae and spinal column, and the associated muscles including those at and around the shoulders, vertebrae, atlas, axis, back, jowls, and face by increasing circulation, including blood circulation, to those areas.

Conveniently, in one embodiment, the unitary construction of hood 100 is very easy to install. For instance, one need merely pick up the hood and place it over the horse's head and neck so that cutout 112 goes over ear 108, and cutout 116 goes over eye 107. Then, fold attachment straps 122, 123, 126 and 128 across the horse's jaw, throat and windpipe regions to secure the hood. The hook material on the ends of the attachment straps readily engage the loop-like material on the outer surface of the hood and linings. There is no concern about detachment of the hood or individual magnetic strips becoming displaced. The magnetic therapy works naturally and automatically.

The use of other equine devices, wraps, patches, pads, blankets, and equipment with the magnetic equine hood is within the scope and contemplation of the invention. For example, as shown in FIG. 1, halter 170 is secured on the horse underneath head portion 110, and leadline 172 is attached to halter 170. Additionally, a blanket may be placed over a portion of hood 100 or an additional hood may be placed over head portion 110. For instance, an equine blanket having therapeutic magnetic strips may be used in concert with the magnetic equine hood.

Moreover, in another example, a blanket may be used in cooperation or incorporated with the hood, such as by coupling the blanket to the hood on the inside or outside surface of hood 100 along a rearward edge perimeter of neck portion 130. For example, FIG. 6 is a perspective view of an equine blanket and magnetic equine hood placed on a horse, according to one embodiment. Coupled to neck portion 130, FIG. 6 shows blanket 610 defining a volume substantially conforming to an equine body. Thus, blanket 610 can have side walls with a shape approximating an equine or horse midsection (e.g., including an equine shoulder, back, barrel, thigh, and/or abdomen, such as shown at 640) and may be adapted to conform in shape to an equine midsection when used. As shown, blanket 610 is coupled to neck portion 130 along or proximate to neck portion rearward edge perimeter 620 of hood 100, which runs along front edge perimeter 660 of blanket 610. For instance, the edge, inside, or outside of front edge perimeter 660 can be coupled to the edge, inside, or outside of rearward edge perimeter 620. As a result, as shown, blanket 610 encases, encircles, surrounds, and/or is secured to horse midsection 640.

Embodiments include blanket/hood permanent couplings or attachments as well as blanket/hood detachable or decouplable couplings. Thus, blanket 610 can be incorporated with hood 100, by coupling blanket 610 by permanent or detachable attachment, prior to or after placing blanket 610 and/or hood 100 over the horse. Specifically, blanket 610 may be permanently attached to neck portion 130 of hood 100 along or proximate to neck portion rearward edge perimeter 620, such as by sewing, stitching, adhesive, heat, welding or any other conventional manner. Embodiments also include where blanket 610 and neck portion 130 consist substantially of one piece of material or have material crossing over withers 650, so that they are joined together without requiring coupling.

In addition, blanket 610 may be detachably coupled to neck portion 130 of hood 100 along or proximate to neck portion rearward edge perimeter 620, such as by using hook and loop material, and/or attachment straps, such as described above with respect to attachment material and means for strap 122 and lining 121. For example, an upper or outside surface of front edge perimeter 660 may have a hook material backing for detachably coupling to a loop-like material receive on the lower or inside surface of rearward edge perimeter.

According to embodiments, various parts of an equine blanket coupled to hood 100 (e.g., such as blanket 610) may be constructed from various materials including a mixture of polyester, rayon, wool, cotton, an elastic webbing or other durable natural or synthetic material (e.g., such as one or more sheets “fishnet” type nylon mesh), and/or a wicking material (e.g., such as DuPont COOLMAX®, CORDURA), as described above with respect to the material makeup of equine hood 100 and it's parts. Consequently, instances of an equine blanket that is shaped to conform to or define a volume conforming to a horse's midsection for proper fit and/or is shaped to conform to the perimeter of a cutout, include blankets designed for use during the winter, summer, and/or various other seasons, as described above with respect to the material makeup of equine hood 100 and it's parts. Note that the although above configurations of blanket material are described with respect to certain seasons of the year, use of those configurations during any or all seasons is within the scope and contemplation of the invention.

Additionally, an equine blanket coupled to hood 100 (e.g., such as blanket 610) may or may not include one or more magnetic strips coupled to the blanket for creating a magnetic field radiating from the magnetic strip towards an equine's vertebrae, shoulder, and thighs or volume disposed within the equine midsection. For example, blanket 610 may include side walls for coupling to one or more bipolar and/or unipolar flexible strips of magnetic material for radiating a magnetic field, such as, a bipolar magnetic field, from the magnetic strips and towards an equine thoracic vertebrae and/or lumbar vertebrae and the soft tissue, muscle, bone, fascia, and ligaments in and around an equine back, as described above with respect to magnetic strips 150 and their associated magnetic fields radiated towards cervical vertebrae. For instance, as shown in FIG. 6, flexible magnetic strip 670 is located proximate to and above the thoracic vertebrae of the horse for radiating a magnetic field from the magnetic strips towards the volume of equine midsection surrounding the thoracic vertebrae. Also, equine blanket magnetic strips (e.g., such as strip 670) may have magnetic material arranged in a bipolar and/or unipolar arrangement, as described above with respect to magnetic strip 150.

Moreover, equine blanket magnetic strips (e.g., such as strip 670) may include material, material covering, and/or lining material, as described above with respect to head portion 110, neck portion 130, and linings 114 and 118. Furthermore, equine blanket magnetic strips (e.g., such as strip 670) may be detachably coupled to an equine blanket (e.g., such as blanket 610) using hook and loop material, and/or attachment straps, such as described above with respect to attachment material and means for strap 122 and lining 121. Conversely, according to embodiments, equine blanket magnetic strips (e.g., such as strip 670) may be fixedly coupled to equine blanket (e.g., such as blanket 610).

Therefore, the placement of each magnetic strip at a strategic area of the blanket, such as is shown by the location of magnetic strip 670 in FIG. 6, enables blanket 610 to provide and soothing magnetic therapy and reduce pain to the joints, ligaments, tendons, fascia, and muscle groups of an equine thoracic vertebrae and/or lumbar vertebrae and the soft tissue, muscle, bone, fascia, and ligaments in and around an equine back.

Consequently, for a magnetic therapy equine blanket (e.g., such as blanket 610) incorporated with hood 100 (e.g., such as by permanent or detachable coupling of blanket 610 to hood 100), the magnetic therapy delivered by the blanket and hood are effective in treating soreness and stiffness along an equine neck, cervical vertebrae, thoracic vertebrae, lumbar vertebrae, shoulders, thighs, atlas, axis, jowls, face and back, and the associated soft tissue, muscle, bone, fascia, and ligaments in and around those areas by increasing circulation, including blood circulation, to those areas.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than restrictive sense.

What is claimed:

1. An apparatus for increasing circulation in an equine neck, the apparatus comprising:
a head portion having a shape substantially conforming to an equine head;
a neck portion coupled to the head portion, the neck portion defining a volume substantially conforming to an equine neck; and
at least one magnetic strip coupled to the neck portion, wherein the magnetic strip creates a magnetic field.

2. The apparatus of claim 1, wherein the head portion defines a muzzle opening, a pair of eye openings and a pair of ear openings.

3. The apparatus of claim 1, wherein the at least one magnetic strip comprises at least one flexible magnetic strip to create a magnetic field radiating from the magnetic strip towards one of a horse cervical vertebrae, a horse axis, a horse atlas, and a horse poll.

4. The apparatus of claim 1, wherein the at least one magnetic strip comprises two flexible magnetic strips, each of the two strips detachably coupled to a side of the neck portion to create a magnetic field radiating from the magnetic strip toward the volume.

5. The apparatus of claim 4, wherein each of the two magnetic strips is detachably coupled to the neck portion to be proximate to either side of a cervical vertebrae of the equine neck when the apparatus is in use.

6. The apparatus of claim 1, wherein the neck portion comprises two side walls to surround the equine neck, wherein each side wall contains at least one flexible magnetic material strip to create a magnetic field radiating from the at least one flexible magnetic material strip toward the volume.

7. The apparatus of claim 1, further comprising an atlas, axis, and cervical vertebrae magnetic strip detachably coupled to both an atlas position pad and axis position pad of the neck portion to create a magnetic field radiating from the atlas, axis, and cervical vertebrae magnetic strip toward a region of the volume to be occupied by an equine atlas, axis, and cervical vertebrae.

8. The apparatus of claim 7, wherein the at least one atlas, axis, and cervical vertebrae magnetic strip comprises a magnetic material that creates a bipolar magnetic field.

9. The apparatus of claim 7, wherein the at least one atlas, axis, and cervical vertebrae magnetic strip comprises a flexible magnetic material and is adapted to be detachably attached to a dorsal position of the apparatus along a central line of the neck portion proximate to the head portion.

10. The apparatus of claim 1, wherein the magnetic field created is a bipolar magnetic field.

11. The apparatus of claim 1, wherein the at least one magnetic strip comprises a flexible magnetic material having a plurality of magnetic fields arranged such that pairs of adjacent magnetic fields have a bipolar magnetic arrangement.

12. The apparatus of claim 1, wherein the at least one magnetic strip comprises a magnetic material that creates a unipolar magnetic field.

13. The apparatus of claim 1, wherein the at least one magnetic strip has a magnetic field strength in the range of 50 gauss to 1000 gauss.

14. The apparatus of claim 1, wherein the at least one magnetic strip comprises two flexible magnetic material strips that create a bipolar magnetic field having a magnetic field strength on the order of 450 gauss, and
wherein each flexible magnetic material strip is about 25.5″ by 5″ and has one of a hook material backing and a loop material backing for detachably coupling to one of a loop material receive and a hook material receive on the neck portion.

15. The apparatus of claim 1, wherein the at least one magnetic strip comprises one of a magnetic paste and a magnetic plastic.

16. The apparatus of claim 1, wherein the head portion includes at least one fastener to detachably secure the head portion to an equine head.

17. The apparatus of claim 1, wherein the neck portion includes at least one fastener to detachably secure the neck portion to an equine neck.

18. The apparatus of claim 1, further comprising:
at least one head portion fastener to secure the head portion to an equine head, each head portion fastener comprising at least one attachment strap having a first end coupled to a first side wall of the head portion such that each had portion fastener may extend under a bottom of the equine head to detachably couple to second side wall of the head portion; and
at least one neck portion fastener to secure the neck portion to an equine neck, each neck portion fastener comprising at least one attachment strap having a first end coupled to a first side wall of the neck portion such that each had portion fastener may extend under a bottom of the equine neck to detachably couple to second side wall of the neck portion.

19. An apparatus for increasing circulation in an equine neck and back, the apparatus comprising:
a head portion substantially conforming to an equine head and defining a pair of eye openings and a pair of ear openings;
a neck portion having a neck portion distal end coupled to the head portion, the neck portion defining a volume substantially conforming to an equine neck; and
at least one magnetic material strip detachably coupled to the neck portion, each of the at least one magnetic material strips creating a magnetic field radiating from the at least one magnetic material strip towards the volume; and
a body portion coupled to a proximate end of the neck portion, the body portion defining a volume substantially conforming to an equine body midsection; and
at least one magnetic strip coupled to the body portion, wherein the magnetic strip creates a magnetic field.

20. The apparatus of claim 19, wherein the body portion coupling to the proximate end of the neck portion comprises one of a permanent attachment and a detachable coupling.

21. An apparatus for increasing circulation in an equine neck, the apparatus comprising:
a head portion substantially conforming to an equine head and defining a muzzle opening, a pair of eye openings and a pair of ear openings;
a neck portion coupled to the head portion, the neck portion defining a volume substantially conforming to an equine neck; and
two magnetic strips each approximately 25.5″ by 5″ detachably coupled to the neck portion, wherein each magnetic strip comprises:
a magnetic material that creates a bipolar magnetic field having a strength of approximately 450 gauss and radiating from the magnetic material towards the equine neck;
a backing material of either a hook material or a loop material to detachably couple each strip to an interior wall of the neck portion.
